(19) United States
(12) Patent Application Publication
(10) Pub. No.: US 2014/0360662 A1
(43) Pub. Date: Dec. 11, 2014

(54) SUBSTRATE BONDING APPARATUS AND METHOD OF MANUFACTURING DISPLAY DEVICE

(71) Applicant: Samsung Display Co., Ltd., Yongin-City (KR)

(72) Inventors: Young In LIM, Cheonan-si (KR); Kyu Ho JUNG, Osan-si (KR); Sang Hee CHOI, Daegu (KR)

(73) Assignee: Samsung Display Co., Ltd., Yongin-City (KR)

(21) Appl. No.: 14/160,296

(22) Filed: Apr. 7, 2014

(30) Foreign Application Priority Data
Jun. 7, 2013 (KR) 10-2013-0065346

(51) Int. Cl. B32B 37/00; B29C 65/00

(52) U.S. Cl. CPC B32B 37/003; B29C 66/342
USPC 156/275.7; 156/379.6; 156/379.8

(57) ABSTRACT

An apparatus and system for bonding substrates are presented. The apparatus includes a base member formed of an insulating material and an electric field generation part formed of a conductive material. The electric field generation part extends into the base member. The electric field generation part includes a trunk part and a branch part. The trunk part extends in a first direction. The branch part extends from the trunk part in a direction different from the first direction. A substrate is fixed on the base member. An adhesive is applied on the substrate in a shape that matches that of the electric field generation part. An electric field is generated using the electric field generation part and the substrate is bonded to another substrate. The apparatus prevents or reduces formation of air bubbles in the adhesive. A method of manufacturing a display device is also presented.

### CROSS-REFERENCE TO RELATED APPLICATION

This U.S. non-provisional patent application claims priority, under 35 U.S.C. §119, to Korean Patent Application No. 10-2013-0065346 filed on Jun. 7, 2013 in the Korean Intellectual Property Office, the disclosure of which is hereby incorporated by reference in its entirety.

### BACKGROUND

The inventive concepts relate generally to an apparatus for bonding substrates and methods of manufacturing a display device and, more particularly, to stages capable of preventing an air bubble from forming in an adhesive layer between two substrates, substrate bonding apparatuses including the same, and methods of manufacturing the same.

An organic light emitting diode (OLED) includes an organic material that emits light using electroluminescent phenomenon whereby light is emitted by applying a current to a fluorescence organic compound. OLEDs are expected by many people to be the next-generation display that replaces liquid crystal display devices because of the numerous advantages they offer. These advantages include low driving voltages, thinness, wide viewing angles and fast response speeds.

Manufacturing OLED display devices often involve bonding a cover window to an organic light emitting display panel. The cover window enhances impact resistance of the organic light emitting display panel and improves visibility.

During the bonding process, an adhesive may be applied to one of the organic light emitting display panel and the cover window. Then, the two substrates (i.e., the organic light emitting display panel and the cover window) may be bonded to each other by a substrate bonding apparatus.

Recently, organic light emitting display panels have been getting larger, along with the cover windows. When the panels get beyond a certain size, the adhesive may not be uniformly spread between the organic light emitting display panel and the cover window. Additionally, air bubbles may form within the adhesive layer. The air bubbles may weaken an adhesive strength of the adhesive.

### SUMMARY

Embodiments of the inventive concepts may provide an apparatus capable preventing an air bubble from forming in an adhesive between two substrates, substrate bonding apparatuses, and methods of manufacturing a display device.

In one aspect, the inventive concept includes an apparatus for bonding substrates that includes: a base member formed of an insulating material; and an electric field generation part formed in the base member. The electric field generation part is formed of a conductive material. The electric field generation part includes a trunk part and a branch part. The trunk part extends in a first direction, and the branch part extends from the trunk part in a direction different from the first direction.

In some embodiments, the branch part may be connected to at least one of first and second ends of the trunk part and extend toward a corner of the base member.

In some embodiments, the electric field generation part may be formed of aluminum.

In some embodiments, the base member may be formed of polyetheretherketone (PEEK)

In another aspect, the inventive concept includes a substrate bonding system that includes: a lower stage fixing a first substrate; and an upper stage being configured to move in different directions. The upper stage may include: a base member formed of an insulating material; and an electric field generation part formed in the base substrate. The electric field generation part may be formed of a conductive material. The electric field generation part may include: a trunk part extending in a first direction; and a branch part extending from the trunk part in a direction different from the first direction.

In some embodiments, the substrate bonding system may further include: a bonding unit configured to move the upper stage in toward and away from the lower stage.

In some embodiments, the substrate bonding system may further include: a power supply part including a voltage source having an anode and a cathode. A top surface of the lower stage may be formed of a conductive material. One of the anode and cathode may be electrically connected to the electric field generation part and the other of the anode and cathode may be electrically connected to the lower stage.

In still another aspect, the inventive concept pertains to a method of manufacturing a display device that includes: fixing a first substrate on a top surface of a lower stage; fixing a second substrate on a bottom surface of an upper stage including a base member formed of an insulating material and an electric field generation part formed in the base member, the electric field generation part formed of a conductive material, and the electric field generation part including a trunk part extending in a first direction and a branch part extending from the trunk part in a direction different from the first direction; applying an adhesive on the second substrate; connecting the electric field generation part to one of an anode and a cathode; connecting the top surface of the lower stage to the other of the anode and the cathode; and bonding the first substrate and the second substrate to each other.

In some embodiments, the adhesive may be applied to match the shape of the electric field generation part in a plan view.

### BRIEF DESCRIPTION OF THE DRAWINGS

The inventive concepts will become more apparent in view of the attached drawings and accompanying detailed description.

FIG. 1 is a schematic structure view illustrating a substrate bonding apparatus according to example embodiments of the inventive concepts;

FIG. 2 is a perspective view illustrating an upper stage of FIG. 1;

FIG. 3 is a cross-sectional view taken along a line I-I′ of FIG. 2;

FIG. 4 is an exploded perspective view illustrating an upper stage, a second substrate, and an adhesive;

FIG. 5A is a schematic structure view illustrating the adhesive before the electric field is generated;

FIG. 5B is a schematic structure view illustrating the adhesive after the electric field(E) is generated; and

FIGS. 5 to 8 are plan views of upper stages according to other embodiments of the inventive concepts.

### DETAILED DESCRIPTION OF THE EMBODIMENTS

The inventive concepts will now be described more fully hereinafter with reference to the accompanying drawings, in which exemplary embodiments of the inventive concepts are shown. The advantages and features of the inventive concepts and methods of achieving them will be apparent from the following exemplary embodiments that will be described in more detail with reference to the accompanying drawings. It should be noted, however, that the inventive concepts are not limited to the following exemplary embodiments, and may be implemented in various forms. Accordingly, the exemplary embodiments are provided only to disclose the inventive concepts and let those skilled in the art know the category of the inventive concepts. In the drawings, embodiments of the inventive concepts are not limited to the specific examples provided herein and are exaggerated for clarity.

The terminology used herein is for the purpose of describing particular embodiments only and is not intended to limit the invention. As used herein, the singular terms “a,” “an” and “the” are intended to include the plural forms as well, unless the context clearly indicates otherwise. As used herein, the term “and/or” includes any and all combinations of one or more of the associated listed items. It will be understood that when an element is referred to as being “connected” or “coupled” to another element, it may be directly connected or coupled to the other element or intervening elements may be present.

Similarly, it will be understood that when an element such as a layer, region or substrate is referred to as being “on” another element, it can be directly on the other element or intervening elements may be present. In contrast, the term “directly” means that there are no intervening elements. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

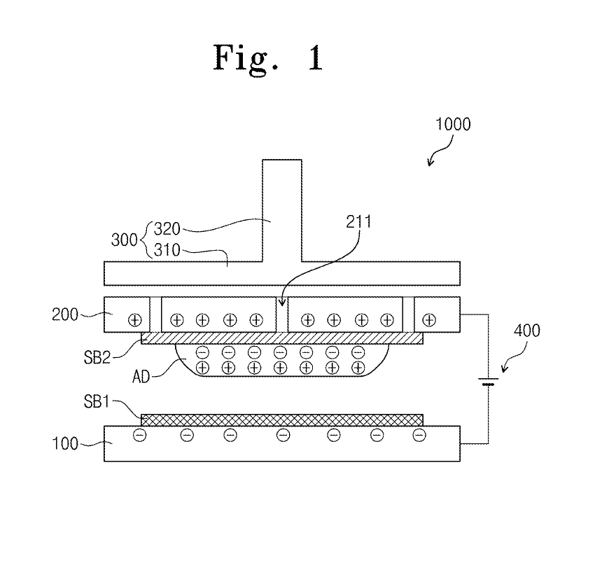

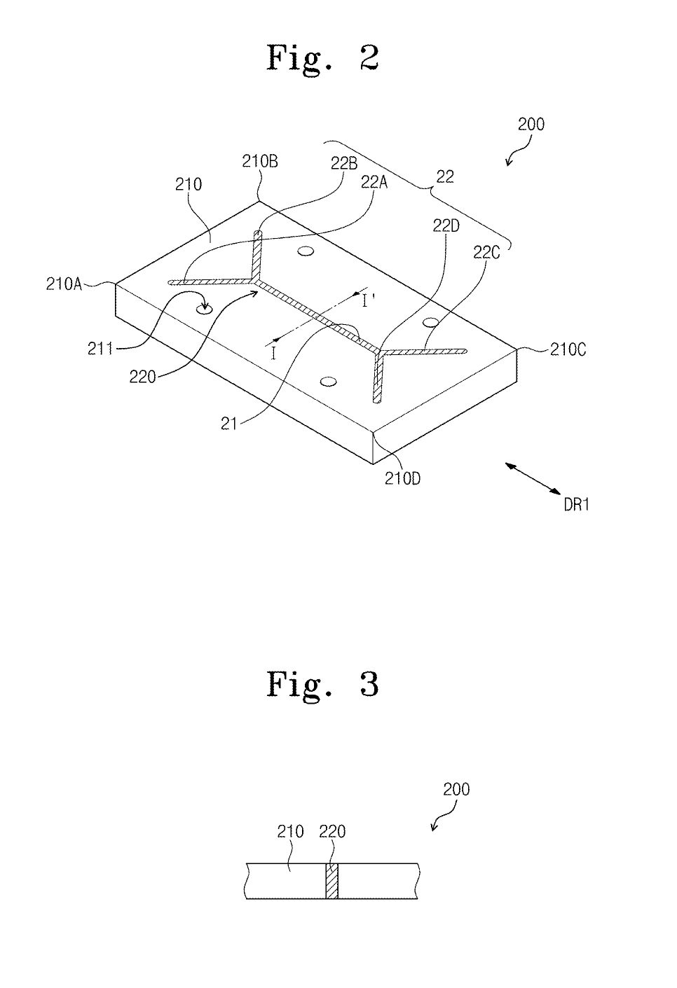

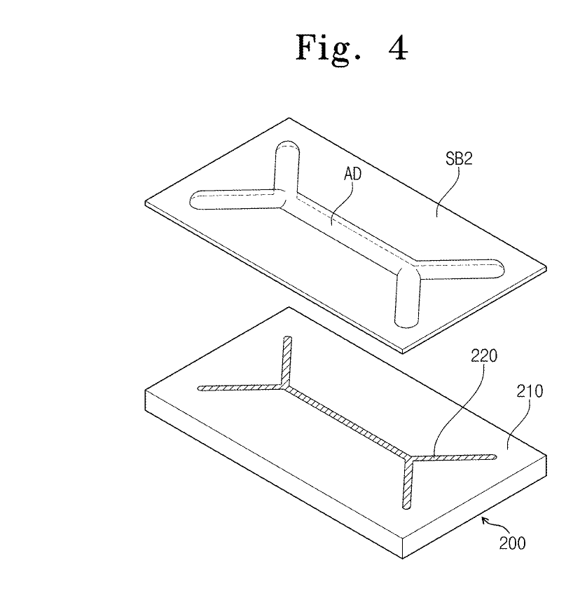

FIG. 1 is a schematic structure view illustrating a substrate bonding apparatus 1000 according to example embodiments of the inventive concepts. FIG. 2 is a perspective view illustrating an upper stage of FIG. 1. FIG. 3 is a cross-sectional view taken along a line I-I′ of FIG. 2. FIG. 4 is an exploded perspective view illustrating an upper stage, a second substrate, and an adhesive.

The substrate bonding apparatus 1000 is used to bond two substrates using an adhesive material during a manufacturing process for a display device. For example, in manufacturing an organic light emitting display device, the substrate bonding apparatus 1000 may be used to bond a cover window to a display panel by using an adhesive. Hereinafter, a first substrate SB1 may be the display panel and a second substrate SB2 may be the cover window. However, the inventive concepts are not limited thereto. The substrate bonding apparatus 1000 may be used in various processes in which two substrates are coupled.

Referring to FIGS. 1 to 3, the substrate bonding apparatus 1000 includes a lower stage 100, an upper stage 200, a bonding unit 300, and a power supply part 400.

The lower stage 100 holds the first substrate SB1 in the desired position. The first substrate SB1 may be safely supported on a top surface of the lower stage 100. In one embodiment, the lower stage 100 mechanically fixes the first substrate SB1 using a fixing unit (not shown). However, the inventive concepts are not limited thereto. In other embodiments, the lower stage 100 may fix the first substrate SB1 by vacuum adsorption. At least the top surface of the lower stage 100 (the stage that faces the first substrate SB1) may be formed of a conductive material.

The upper stage 200 may be disposed over the lower stage 100. The upper stage 200 may be spaced apart from the lower stage 100 and may hold the second substrate SB2 in the desired position. The second substrate SB2 may be safely disposed on a bottom surface of the upper stage 200. The inventive concept is not limited to any specific shape of the upper stage 200. In the embodiment that is depicted, the upper stage 200 may have a quadrilateral plate-shape.

The upper stage 200 may include a base member 210 and an electric field generation part 220. The base member 210 may be formed of an insulating material, for example, polyetheretherketone (PEEK).

The base member 210 may include a plurality of adsorption sections 211. The adsorption sections 211 are spaced apart from the electric field generation part 220. The adsorption sections 211 extend through the entire thickness of the base member 210. The upper stage 200 may attach to the second substrate SB2 through the adsorption section 211 such that the second substrate SB2 may be fixed on the upper stage 200. The adsorption sections 211 may be a hole which a vacuum is applied.

The electric field generation part 220 extends through the entire thickness of the base member 210. That is, the electric field generation part 220 is inserted or embedded in the base member 210, such that the base member 210 and the electric field generation part 220 have a flush surface. The electric field generation part 220 may be formed of a conductive material, for example, aluminum.

The electric field generation part 220 may include a trunk part 21 and a branch part 22. The trunk part 21 may extend in a first direction DR1 in plan view. The trunk part 21 may be disposed to pass the center of the base member 210.

In a plan view, the branch part 22 may extend from the trunk part 21 in a direction different from the first direction DR1.

The branch part 22 may include first, second, third, and fourth branch parts 22A, 22B, 22C, and 22D.

The first and second branch parts 22A and 22B extend from a first end of the trunk part 21. The first branch part 22A may extend from the first end of the trunk part 21 toward a first corner 210A of the base member 210. The second branch part 22B may extend from the first end of the trunk part 21 toward a second corner 210B of the base member 210.

The third and fourth branch parts 22C and 22D extend from a second end of the trunk part 21. The third branch part 22C may extend from the second end of the trunk part 21 toward a third corner 210C of the base member 210. The fourth branch part 22D may extend from the second end of the trunk part 21 toward a fourth corner 210D of the base member 210.

The electric field generation part 220 may have a shape resembling two Y-shaped parts connected to each other by their bases. Hereinafter, a manufacturing method of the upper stage 200 will be described. A base substrate formed of a conductive material is provided. The base member 210 is formed by digging the base substrate for forming a hole. The electric field generation part 220 is formed by cast molding process. The electric field generation part 220 is pressed into the hole of the base member 210.

The bonding unit 300 may include a bonding plate 310 and a transfer part 320. The bonding plate 310 may be disposed to correspond to the upper stage 200. The transfer part 320 may move the bonding plate 310 in a desired direction, such as up and down. The bonding plate 310 may be moved in the down direction to press the upper stage 200 against the lower stage 100, such that the second substrate SB2 fixed on the bottom surface of the upper stage 200 may be bonded to the first substrate SB1 fixed on the top surface of the lower stage 100.

In the embodiments described above, the bonding unit 300 may press the upper stage 200 toward the lower stage 100 (in the downward direction in the embodiment of FIG. 1) to bond the second substrate SB2 to the first substrate SB1. However, the inventive concepts are not limited thereto. In other embodiments, the bonding unit 300 may press the lower stage 100 toward the upper stage 200 (in the upward direction in the embodiment of FIG. 1) to bond the first substrate SB1 to the second substrate SB2.

The power supply part 400 may be connected to the lower and upper stages 100 and 200 to generate a potential difference between the lower and upper stages 100 and 200. An electric field may be generated between the lower and upper stages 100 and 200 by the potential difference. The power supply part 400 may be a voltage source. One of an anode and a cathode of the power supply part 400 may be electrically connected to the electric field generation part 220 of the upper stage 200, and the other of the anode and the cathode of the power supply part 400 may be electrically connected to the top surface of the lower stage 100. Hereinafter, the anode connected to the electric field generation part 220 and the cathode connected to the top surface of the lower stage 100 will be described as an example.

The power supply part 400 may charge the electric field generation part 220 of the upper stage 200 with positive charges and the top surface of the lower stage 100 with negative charges.

Hereinafter, a method of manufacturing a display device using the substrate bonding apparatus 1000 will be described briefly.

The first substrate SB1 is fixed on the top surface of the lower stage 100. The upper stage 200 holds the second substrate SB2 in place through the adsorption sections 211, so that the second substrate SB2 is fixed on the bottom surface of the upper stage 200. Thereafter, an adhesive AD (e.g., a resin) is applied on the second substrate SB2. The adhesive AD is applied to substantially match the shape of the electric field generation part 220 in a plan view (See FIG. 4). In other words, the adhesive AD may be applied to have the shape of two Y-shaped parts connected to each other by their bases.

After the adhesive AD is applied, the anode and the cathode of the power supply part 400 are connected to the electric field generation part 220 and the lower stage 100, respectively. Thus, negative charges may be induced in a region of the adhesive AD that is closest to the upper stage 200, and positive charges may be induced in a region of the adhesive AD that is closest to the lower stage 100.

Thereafter, the first substrate SB1 and the second substrate SB2 are aligned with each other, e.g. with an alignment camera (not shown). Next, the bonding unit 300 presses the upper stage 200 toward the lower stage 100, so that the upper stage 200 is moved downward to bond the second substrate SB2 to the first substrate SB1. In response to the pressure, the adhesive AD may spread out over the entire surfaces of the first and second substrates SB1 and SB2.

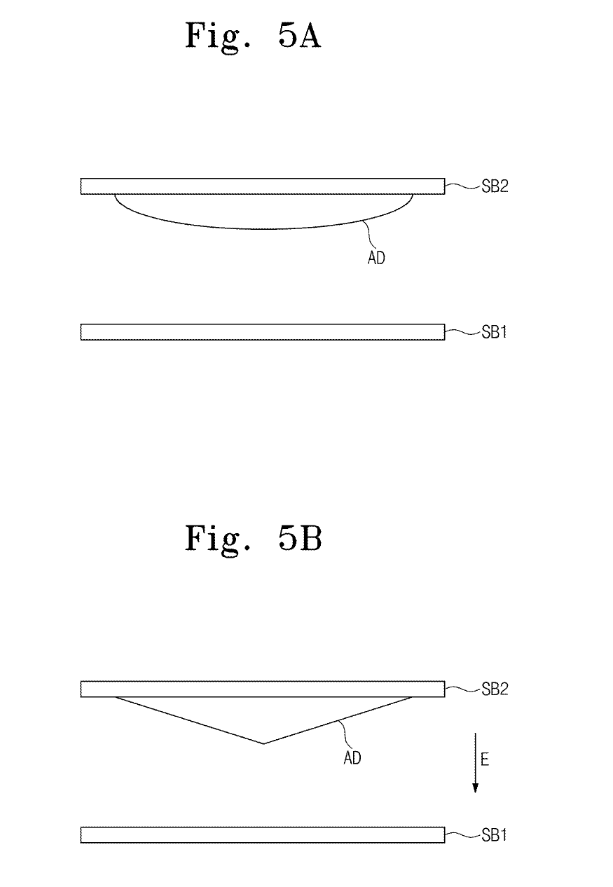

Charge sharpness may occur in a portion of the adhesive AD by the electric field generated between the lower stage 100 and the upper stage 200. The charge sharpness means the adhesive AD becomes sharp in a direction from an upper surface of the adhesive AD electrically connected to the power supply part 400 to a lower surface of the adhesive AD electrically disconnected to the power supply part 400 by the electric field generated. FIG. 5A is a schematic structure view illustrating the adhesive before the electric field is generated. FIG. 5B is a schematic structure view illustrating the adhesive after the electric field (E) is generated. As the first and second substrates SB1 and SB2 become larger and the first and second substrates SB1 and SB2 are formed of a conductive material, the region where the charge sharpness occurs may be increased. a plurality of regions Charge sharpness occurred can cause air bubbles to form in the layer of adhesive AD between the bonded first and second substrates SB1 and SB2 and among the plurality of regions Charge sharpness occurred. However, according to embodiments of the inventive concepts, the electric field generation part 220 has the planar shape described above and the adhesive AD is applied on the second substrate SB2 to correspond to the shape of the electric field generation part 220. Thus, formation of air bubble may be avoided or reduced.

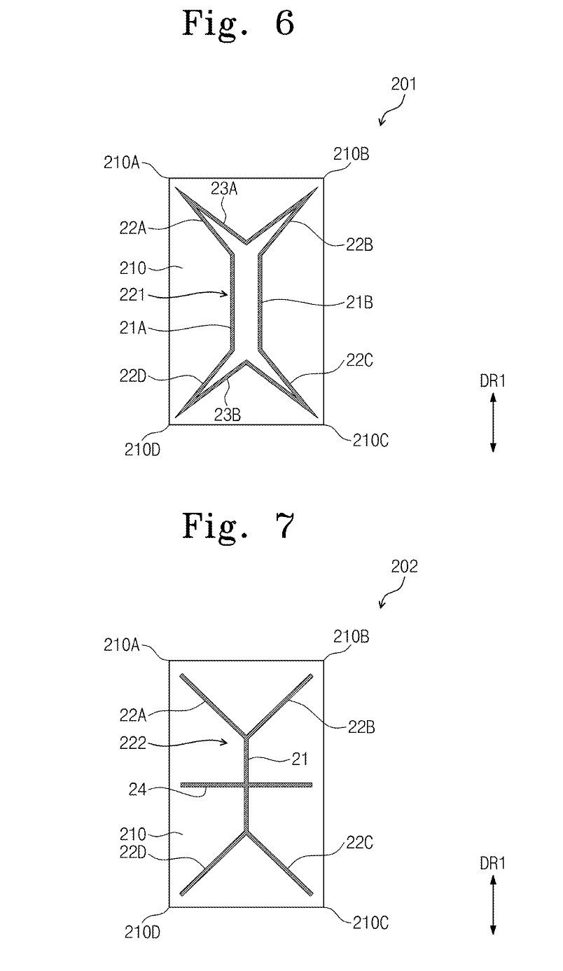

FIGS. 6 to 9 are plan views of upper stages according to other embodiments of the inventive concepts.

Upper stages 201, 202, 203, and 204 illustrated in FIGS. 6 to 9 may include electric field generation parts having different shapes from the electric field generation part 220 of the upper stage 200. Other elements of the upper stages 201 to 204 may be substantially the same as the elements corresponding thereto of the upper stages 200. Thus, the shapes of the electric field generation parts of the upper stages 201 to 204 will be mainly described hereinafter. For the purpose of ease and convenience in explanation, the descriptions to the same elements as in the embodiment of FIGS. 1 to 4 will be omitted or mentioned briefly.

Referring to FIG. 6, an electric field generation part 221 of the upper stage 201 may include trunk parts 21A and 21B, branch parts 22A to 22D, and branch-connecting parts 23A and 23B.

In the embodiment of FIG. 6, there are trunk parts 21A and 21B. The first trunk part 21A and the second trunk part 21B, which are shown by the shaded areas in FIG. 6, may be spaced apart from each other with a center of the base member 210 therebetween. The first and second trunk parts 21A and 21B may extend parallel to each other in a first direction DR1. In the embodiment shown, the first trunk part 21A and the second trunk part 21B are arranged symmetrically with respect to a centerline that extends across the base member 210 in the direction DR1.

In addition to the trunk parts 21A, 21B, there are branch parts 22A to 22D in the embodiment of FIG. 6.

The first branch part 22A may extend from a first end of the first trunk part 21A toward the first corner 210A of the base member 210. The second branch part 22B may extend from the first end of the second trunk part 21B toward the second corner 210B of the base member 210. The third branch part 22C may extend from a second end of the second trunk part 21B toward the third corner 210C of the base member 210. The fourth branch part 22D may extend from the second end of the first trunk part 21A toward the fourth corner 210D of the base member 210.

The branch-connecting parts 23A and 23B may include a first branch-connecting part 23A and a second branch-connecting part 23B.

The first branch-connecting part 23A may connect the first branch part 22A to the second branch part 22B. The first branch-connecting part 23A may connect an end of the first branch part 22A that is closest to the first corner 210A to an end of the second branch part 22B that is closest to the second corner 210B. The first branch-connecting part 23A may have at least one bend, such as the bend toward the first and second trunk parts 21A and 21B shown in FIG. 6. The first branch-connecting part 23A may have a V-shape.

The second branch-connecting part 23B may connect the third branch part 22C to the fourth branch part 22D. The second branch-connecting part 23B may connect an end of the third branch part 22C that is closest to the third corner 210C to an end of the fourth branch part 22D that is adjacent to the fourth corner 210D. The second branch-connecting part 23B may have at least one bend, for example toward the first and second trunk parts 21A and 21B as shown in FIG. 6. The second branch-connecting part 23B may have a V-shape. In the embodiment of FIG. 6, the branch parts 22A, 22B and the branch parts 22C, 22D are arranged symmetrically with respect to a center line that extends across the base member 210 in a direction that is perpendicular to the direction DR1.

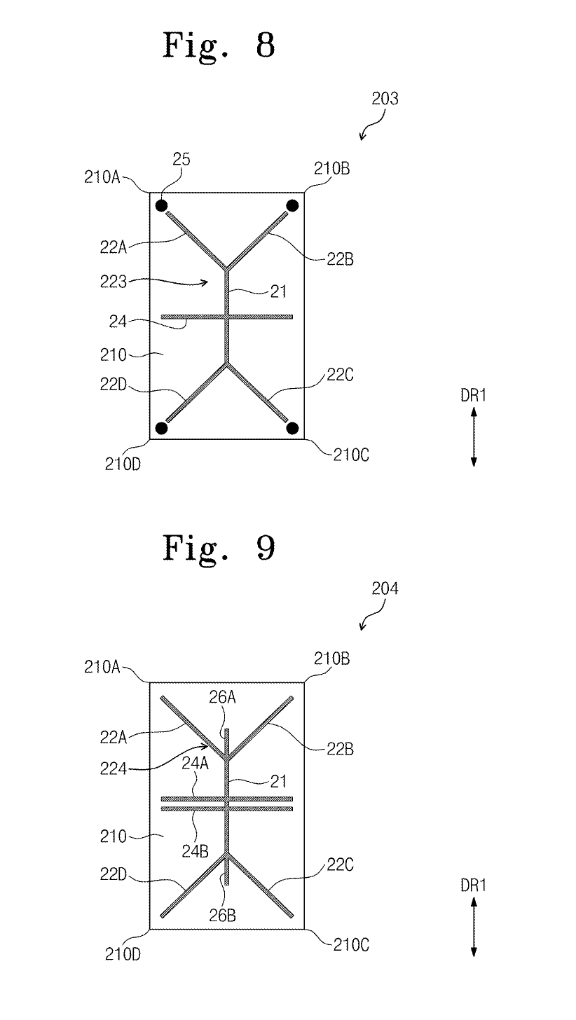

Referring to FIG. 7, an electric field generation part 222 may include the trunk part 21, the first to fourth branch parts 22A to 22D, and a horizontal branch part 24.

The trunk part 21 and the first to fourth branch parts 22A to 22D are substantially the same as illustrated in FIG. 2. Thus, the descriptions thereto are omitted.

The horizontal branch part 24 is disposed to cross the trunk part 21 in a direction perpendicular to the first direction DR1. The horizontal branch part 24 may be spaced apart from the first to fourth branch parts 22A to 22D. The horizontal branch part 24 may be disposed to pass through the center of the base member 210.

Referring to FIG. 8, an electric field generation part 223 may include the trunk part 21, the first to fourth branch parts 22A to 22D, the horizontal branch part 24, and a spot part 25.

The trunk part 21, the first to fourth branch parts 22A to 22D, and the horizontal branch part 24 are substantially the same as illustrated in FIG. 7.

The spot part 25 is disposed between each of the first to fourth branch parts 22A to 22D and each of the first to fourth corners 210A to 210D, respectively. The spot part 25 may be spaced apart from the first to fourth branch parts 22A to 22D and the first to fourth corners 210A to 210D, such that the sport parts 25 are not directly connected to the branch parts 22A, 22B, 22C, 22D or the corners 210A, 210B, 210C, 210D. The spot part 25 may have a circular shape in a plan view, although this is not a limitation of the inventive concept. A diameter or width of the spot part 25 may be greater than a width of each of the first to fourth branch parts 22A to 22D. Fourth spot parts 25 may be formed in/on the base member 210. The sport parts 25 may be made of the same material as the rest of the electric field generation part 224.

Referring to FIG. 9, an electric field generation part 224 may include the trunk part 21, the first to fourth branch parts 22A to 22D, horizontal branch parts 24A and 24B, and trunk extensions 26A and 26B.

The trunk part 21 and the first to fourth branch parts 22A to 22D are substantially the same as illustrated in FIG. 2.

The horizontal branch parts 24A and 24B may include a first horizontal branch part 24A and a second horizontal branch part 24B. The first and second branch parts 24A and 24B are disposed to cross the trunk part 21 in a direction perpendicular to the first direction DR1. The first and second branch parts 24A and 24B are spaced apart from each other by the same distance from a center of the base member 210 therebetween.

The first trunk extension 26A is connected to the first end of the trunk part 21 and extends in the first direction DR1, substantially parallel to the trunk part 21. The second trunk extension 26B is connected to the second end of the trunk part 21 and extends in the first direction DR1, substantially parallel to the trunk part 21. The first and second trunk extensions 26A, 26B may be continuous with the trunk part 21.

According to embodiments of the inventive concepts, occurrence of the air bubble may be prevented or reduced by the planar shape of the electric field generation part and the adhesive applied to correspond to the planar shape of the electric field generation part.

While the inventive concepts have been described with reference to example embodiments, it will be apparent to those skilled in the art that various changes and modifications may be made without departing from the spirits and scopes of the inventive concepts. Therefore, it should be understood that the above embodiments are not limiting, but illustrative. Thus, the scopes of the inventive concepts are to be determined by the broadest permissible interpretation of the disclosure, and shall not be restricted or limited by the foregoing description.

What is claimed is:

1. An apparatus for bonding substrates, the apparatus comprising:
a base member formed of an insulating material; and
an electric field generation part formed in the base member, the electric field generation part formed of a conductive material,
wherein the electric field generation part comprises:
a trunk part extending in a first direction; and
a branch part extending from the trunk part in a direction different from the first direction.

2. The apparatus of claim 1, wherein the electric field generation part is formed of aluminum.

3. The apparatus of claim 1, wherein the base member is formed of polyetheretherketone (PEEK)

4. The apparatus of claim 1, wherein the base member comprises: a plurality of adsorption sections spaced apart from the electric field generation part and extending into the base member.

5. The apparatus of claim 1, wherein the branch part is connected to at least one of first and second ends of the trunk part and extends toward a corner of the base member.

6. The apparatus of claim 5, wherein the base member has a quadrilateral plate-shape having first, second, third, and fourth corners; and
wherein the branch part comprises:
a first branch part extending from the first end of the trunk part toward the first corner;
a second branch part extending from the first end of the trunk part toward the second corner;
a third branch part extending from the second end of the trunk part toward the third corner; and
a fourth branch part extending from the second end of the trunk part toward the fourth corner.

7. The apparatus of claim 6, wherein the electric field generation part further comprises: a horizontal branch part crossing the trunk part in a direction perpendicular to the first direction.

8. The apparatus of claim 7, wherein the electric field generation part further comprises: a spot part disposed between one of the branch parts and one of the first to fourth corners that is closest to the branch part.

9. The apparatus of claim 7, wherein the horizontal branch part comprises: a first horizontal branch part and a second horizontal branch part spaced apart from each other with a center of the base member therebetween; and
wherein the electric field generation part further comprises: trunk extensions connected to the first and second ends of the trunk part and extending in the first direction.

10. The apparatus of claim 5, wherein the base member has a quadrilateral plate-shape having first, second, third, and fourth corners,
wherein the trunk part comprises: a first trunk part and a second trunk part spaced apart from each other with a center of the base member therebetween,
wherein the branch part comprises:
a first branch part extending from a first end of the first trunk part toward the first corner;
a second branch part extending from a first end of the second trunk part toward the second corner;
a third branch part extending from a second end of the second trunk part toward the third corner; and
a fourth branch part extending from a second end of the first trunk part toward the fourth corner,
wherein the electric field generation part further comprises:
a first branch-connecting part connecting an end of the first branch part that is closest to the first corner to an end of the second branch part that is closest to the second corner, the first branch-connecting part having at least one bend; and
a second branch-connecting part connecting an end of the third branch part that is closest to the third corner to an end of the fourth branch part that is closest to the fourth corner, the second branch-connecting part having at least one bend.

11. The apparatus of claim 10, wherein each of the first and second branch-connecting parts has a V-shape.

12. A substrate bonding system comprising:
a lower stage fixing a first substrate; and
an upper stage disposed over the lower stage and fixing a second substrate, the upper stage being configured to move in different directions,
wherein the upper stage comprises:
a base member formed of an insulating material; and
an electric field generation part formed in the base substrate, the electric field generation part formed of a conductive material,
wherein the electric field generation part comprises:
a trunk part extending in a first direction; and
a branch part extending from the trunk part in a direction different from the first direction.

13. The substrate bonding system of claim 12, further comprising:
a bonding unit configured to move the upper stage in toward and away from the lower stage.

14. The substrate bonding system of claim 12, further comprising:
a power supply part including a voltage source having an anode and a cathode,
wherein a top surface of the lower stage is formed of a conductive material; and
wherein one of the anode and cathode is electrically connected to the electric field generation part and the other of the anode and cathode is electrically connected to the lower stage.

15. The substrate bonding system of claim 12, wherein the branch part is connected to at least one end of the trunk part and extends toward a corner of the base member.

16. A method of manufacturing a display device, the method comprising:
fixing a first substrate on a top surface of a lower stage;
fixing a second substrate on a bottom surface of an upper stage including a base member formed of an insulating material and an electric field generation part formed in the base member, the electric field generation part formed of a conductive material, and the electric field generation part including a trunk part extending in a first direction and a branch part extending from the trunk part in a direction different from the first direction;
applying an adhesive on the second substrate;
connecting the electric field generation part to one of an anode and a cathode;
connecting the top surface of the lower stage to the other of the anode and the cathode; and
bonding the first substrate and the second substrate to each other.

17. The method of claim 16, wherein the adhesive is applied to match shape of the electric field generation part.

18. The method of claim 16, wherein the second substrate is adsorbed and fixed on the bottom surface of the upper stage through a plurality of adsorption sections penetrating the base member; and
wherein the plurality of adsorption sections are spaced apart from the electric field generation part.
